(19) United States
(12) Patent Application Publication
(10) Pub. No.: US 2022/0398390 A1
(43) Pub. Date: Dec. 15, 2022

(54) SPECIAL TAG TO BE INSERTED INTO STRUCTURE FOR FACTORY AUTOMATION, AND METHOD OF MANUFACTURING SAME

(71) Applicant: Ji Hoon LEE, Seoul (KR)

(72) Inventor: Ji Hoon LEE, Seoul (KR)

(21) Appl. No.: 17/747,320

(22) Filed: May 18, 2022

(30) Foreign Application Priority Data
May 25, 2021 (KR) 10-2021-0067106

(51) Int. Cl. G06K 7/10; G06K 19/07

(52) U.S. Cl. CPC G06K 7/10366; G06K 19/0723

(57) ABSTRACT

A special tag to be inserted into a structure for factory automation, and a method of manufacturing the same are proposed. The structure for the factory automation includes: a cylindrical cylinder included in a factory automation facility; a groove formed at an end of one side of the cylindrical cylinder; and a tag inserted into the groove and provided with a unique number (ID) input into an IC chip.

### CROSS REFERENCE TO RELATED APPLICATION

The present application claims priority to Korean Patent Application No. 10-2021-0067106, filed

May 25, 2021, the entire contents of which is incorporated herein for all purposes by this reference.

### BACKGROUND OF THE INVENTION

### Field of the Invention

The present disclosure relates to a special tag required for factory automation.

More particularly, the present disclosure relates to a technology on an RFID tag device and a method of manufacturing the same, wherein the RFID tag device is manufactured in a special customized type for a factory automation facility and is inserted into a structure, so as to be used for productivity improvement in production management, inventory management, history management, etc.

### Description of the Related Art

In general, an RFID tag (hereinafter abbreviated as “tag”) is also called a transponder, and is configured to store data that is read from a tag unique ID or a sensor and transmit information in various ways when a reader requests the information.

A hardware configuration of the tag includes an IC chip and an antenna. (See FIG. 1)

Functionally, the tag is composed of a memory, a modulator, a clock generator, an encoder, a commander detector, and a rectifier.

Meanwhile, according to the present disclosure, the tag is applied to a structure of a factory automation facility.

FIGS. 2A-2B are a cylindrical cylinder, which is a structure that rotates in synchronization with rotation of a shaft (not shown).

The tag is attached to a rotating cylindrical cylinder, so as to be used for factory automation.

### Documents of Related Art

(Patent Document 1) Korean Patent Application Publication No. 10-2007-0093721 (published on Sep. 19, 2007)

### SUMMARY OF THE INVENTION

Meanwhile, when a tag is attached to an outer surface of a structure for factory automation, there are frequent problems that the tag protruding from the outer surface of the structure is damaged.

In addition, even when structures need to be stacked in multiple layers, it is sometimes inconvenient to stack the structures in the multiple layers due to space variations because a tag is exposed on the outer surface of each structure. For example, there are problems that the stacked structures may lose balance and fall over or aesthetic issues may occur.

In addition, a third party may arbitrarily replace a tag, so it is necessary to prevent such an incident as well.

In FIG. 3, structures stacked in three layers are illustrated as an example, wherein the structures occupy respective volumes large in space due to respectively attached tags, and the probability of imbalance and falling is high.

Conventionally, a tag in a form of a sticker may be attached to an outer surface of a structure, or a metal tag may be attached to an outer side of the structure using an adhesive, bolts, or rivets. However, in the present patent, the tag to be inserted into the structure may be manufactured, so as to be used semi-permanently without damage.

In addition, the present patent may enable the tag to be protected from external environmental factors.

In addition, since propagation transmission characteristics may be affected depending on materials of the structure into which the tag is inserted, an antenna pattern of the tag is appropriately changed, so as to manufacture a tag having optimal performance.

According to the present disclosure, a special customized tag and a structure are manufactured and applied to a factory automation facility, whereby effects are expected such that productivity in the production management, inventory management, history management, etc. are maximally increased and production costs are reduced.

### BRIEF DESCRIPTION OF THE DRAWINGS

FIG. 1 is a view illustrating an exemplary embodiment of a general RFID tag.

FIGS. 2A-2B are views illustrating a cylindrical cylinder used in a factory automation facility.

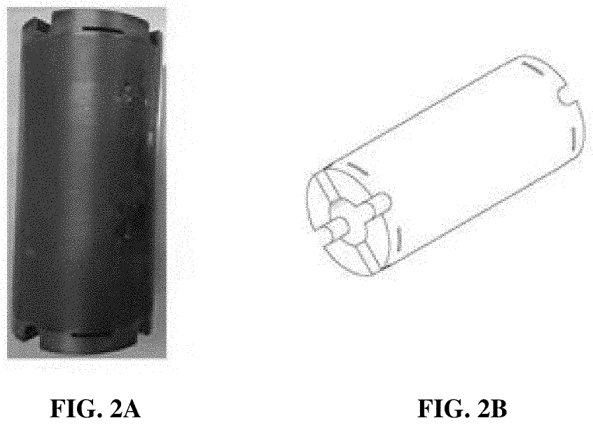

FIG. 3 is a view illustrating that tags are attached to respective cylindrical cylinders stacked in multiple layers.

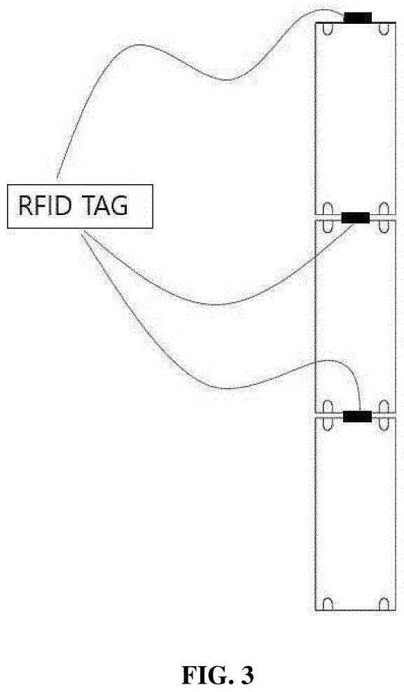

FIG. 4 is a view illustrating an exemplary embodiment of a groove for inserting the tag into the cylindrical cylinder according to the present disclosure.

FIG. 5 is a view illustrating that the cylindrical cylinders into which respective tags are inserted are stacked in multiple layers according to the present disclosure.

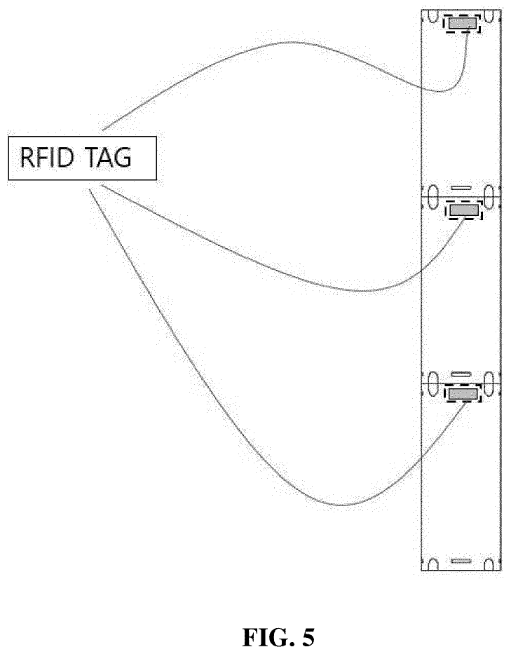

FIG. 6 is a view illustrating an exemplary embodiment for measuring performance of a tag antenna inserted into the cylindrical cylinder according to the present disclosure.

FIG. 7 is a view illustrating an exemplary embodiment in which a length of the tag is changed by cutting the antenna according to the present disclosure.

### DETAILED DESCRIPTION OF THE INVENTION

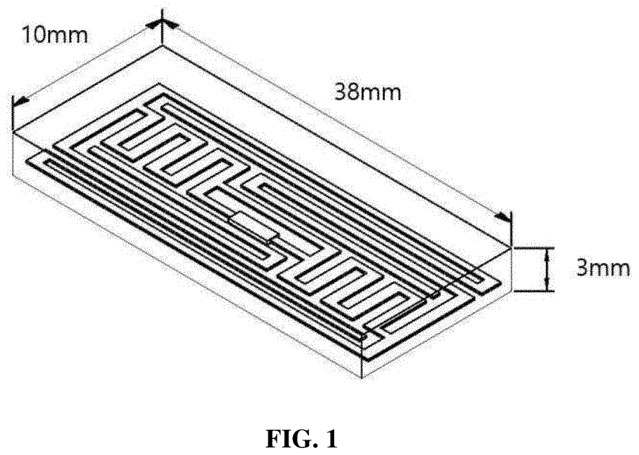

A method in which a tag included in the exemplary embodiment of the present disclosure is manufactured and used on the basis of a size of which the width×length×height is 38×10×3 (mm) disclosed in FIG. 1 will be described.

The size is only a means for disclosing the exemplary embodiment of the present disclosure, and is not intended to limit the tag to a specific size, and it should be understood that all changes, equivalents, or substitutes included in the spirit and scope of the present disclosure are included in the present patent.

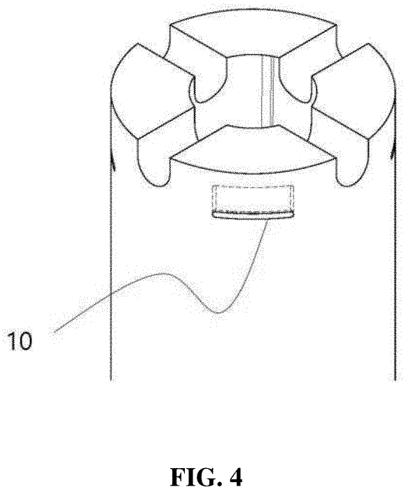

A first exemplary embodiment of the present disclosure is to insert a tag into a cylindrical cylinder as shown in FIG. 4.

First, a groove 10 for inserting the tag into an end of a side surface of the cylindrical cylinder that rotates in synchronization with rotation of a shaft (not shown) is made.

The groove 10 is a rectangular parallelepiped cavity, and should be larger than the size of the tag because of having to include space for inserting a rectangular parallelepiped-shaped tag and even space where a material for sealing the outside of the groove is to be positioned.

Next, the tag according to the present disclosure is inserted into the groove 10 of the cylindrical cylinder.

Before the tag is inserted, an individual unique number (ID) is input to an IC chip.

The tag inserted into the groove 10 is combined with the cylindrical cylinder by using an adhesive such as silicone, and then sealed therein.

Preferably, the tag and the groove 10 into which the tag is inserted are not limited to a rectangular parallelepiped, and may be manufactured in various shapes including a circular shape.

When the tag is attached to the outer surface of the structure conventionally, multi-layer stacking is inconvenient and various problems occur. However, in the present disclosure, according to the exemplary embodiment in which the tag is inserted into the inner groove 10 of the cylindrical cylinder and sealed therein, the cylindrical cylinder is able to maintain the balance thereof even when stacked in multiple layers, the efficiency of space for stacking the structures is greatly improved, and the tag is able to be used semi-permanently without damage and to be protected from the influence of an external environment because the tag is not exposed to the outside.

A second exemplary embodiment of the present disclosure is proposed on the continuation of the first exemplary embodiment.

In the first exemplary embodiment of the present disclosure, the groove is generated in the cylindrical cylinder into which the tag is inserted and the tag is sealed therein. In this case, due to an influence of the cylindrical cylinder surrounding and in close contact with the tag, there may occur antenna performance deterioration compared to that of a case where a tag is attached to the outer surface of a cylindrical cylinder.

The reason is because as the antenna of the tag is completely sealed inside the structure, an impedance change appears around the antenna depending on materials of the cylindrical cylinder.

Such an impedance change may appear as the antenna performance deterioration, and thus the antenna performance of the tag inserted into the cylindrical cylinder is tested in a 900 MHz frequency band used for structures for factory automation, so as to improve the performance deterioration.

First, propagation characteristics of a tag are measured according to insertion and seal of an antenna into a structure.

A test method is as follows:

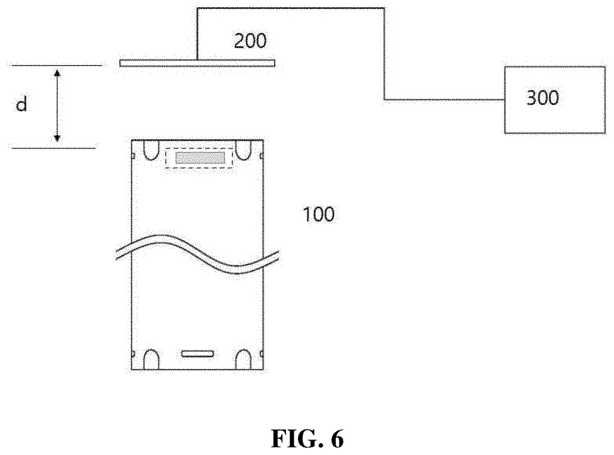

1. Connecting a test device as shown in a measurement wiring diagram (in FIG. 6).

(100) tag-inserted cylindrical cylinder

(200) antenna for data measurement

(300) tag reader for data measurement

(d) recognition distance

2. Inserting a tag into a groove of a cylindrical cylinder.

3. Measuring an output at which the tag is recognized while changing a distance, and while rotating the cylindrical cylinder.

Selecting a recognition distance, at which an optimal output is obtained, among the changed distances.

4. Repeating the measurement by changing a tag pattern (length) at the optimal recognition distance, while rotating the cylindrical cylinder.

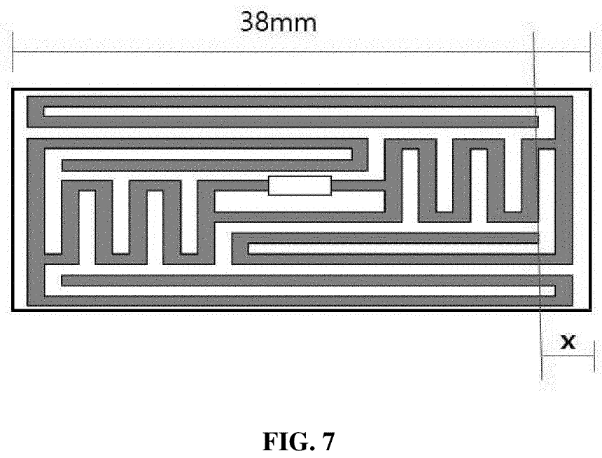

The change of the tag pattern (length) is measured by reducing the length of the tag while gradually cutting an end of one side of the tag from outside to inside as shown in FIG. 7.

5. Determining a tag length that exhibits the optimal output.

The measurement result for the recognition distances is shown in Table 1 below.

TABLE 1

| Recognition • Distance • (cm) | Performance • (%) |
|---|---|
| 5 | 10 |
| 10 | 20 |
| 20 | 40 |
| 30 | 60 |
| 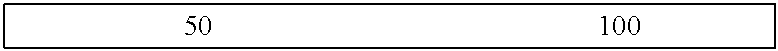 | |
| 60 | 80 |

Antenna recognition performance is the highest when the tag is spaced 50 cm apart as shown in the table above, and the test is iteratively performed while reducing the antenna length of the tag from the optimal recognition distance.

The measurement result according to the cutting of the antenna of the tag is shown in Table 2 below.

TABLE 2

| Tag • Cutting • (mm) | Performance • (%) |
|---|---|
| 0 | 10 |
| 0.5 | 30 |
| 1.0 | 70 |
| 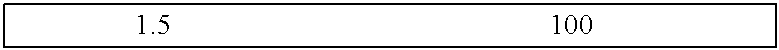 | |
| 2.0 | 72 |
| 2.5 | 45 |

In the present disclosure, a tag having a length of 38 mm is tested as a subject.

The tag having a length of 36.5 mm and a recognition distance d of 50 cm and in which the antenna of the tag is cut by 1.5 mm is measured to have the highest performance.

Propagation performance is improved as the antenna of the tag is cut bit by bit, but as the tag is cut in excess of 1.5 mm, the propagation performance is decreased again.

As in the present disclosure, when a specific structure is manufactured so that the maximum efficiency of a special customized tag may be obtained in consideration of factors of an external environment, reading performance of the tag may be improved and manufacturing efficiency may be maximally increased.

What is claimed is:

1. A structure for factory automation, the structure comprising:
a cylindrical cylinder included in a factory automation facility;
a groove (10) formed at an end of one side of the cylindrical cylinder; and
a tag inserted into the groove (10) and provided with a unique number (ID) input into an IC chip,
wherein productivity improvement is maximally increased and production costs are reduced.

2. The structure of claim 1, wherein the tag inserted into the groove (10) is bonded by using an adhesive and sealed therein.

3. The structure of claim 1, wherein the tag comprises the IC chip and an antenna.

4. The structure of claim 3, wherein the tag is manufactured by measuring and selecting an optimal recognition distance by an antenna for data measurement and a tag reader for the data measurement.

5. The structure of claim 3, wherein the tag is manufactured by measuring and selecting a length of an optimal tag pattern by the antenna for the data measurement and the tag reader for the data measurement.

6. A method of manufacturing a structure for factory automation, the method comprising:
making a groove (10) for inserting a tag in an end of one side surface of a cylindrical cylinder that rotates in synchronization with rotation of a shaft;
inputting an individual unique number (ID) into an IC chip of the tag;
inserting the tag into the groove (10) of the cylindrical cylinder; and
bonding and sealing the tag inserted into the groove (10) to the cylindrical cylinder by using an adhesive,
wherein productivity improvement is maximally increased and production costs are reduced.

7. The method of claim 6, further comprising:
a process of testing propagation characteristics in order to select a recognition distance at which an optimal output is obtained from the tag inserted into the cylindrical cylinder.

8. The method of claim 7, further comprising:
a process of testing the propagation characteristics in order to determine a length of the tag inserted into the cylindrical cylinder.

9. A method of manufacturing a special tag for factory automation, the method comprising:
inserting a tag into a groove of a cylindrical cylinder;
measuring an output at which the tag is recognized while changing a distance, and while rotating the cylindrical cylinder;
selecting a recognition distance at which an optimal output is obtained;
measuring an output while reducing a tag length by cutting an end of one side of the tag from outside to inside at the recognition distance at which the optimal output is obtained, while rotating the cylindrical cylinder; and
determining the tag length that exhibits the optimal output, wherein productivity improvement is maximally increased and production costs are reduced.

10. A special tag for factory automation, the special tag comprising:
a tag manufactured by the method of the manufacturing the special tag of claim 9 and used by being inserted into a structure for the factory automation.

11. The structure of claim 4, wherein the tag is manufactured by measuring and selecting a length of an optimal tag pattern by the antenna for the data measurement and the tag reader for the data measurement.
